(19) United States
(12) Patent Application Publication
(10) Pub. No.: US 2024/0261676 A1
(43) Pub. Date: Aug. 8, 2024

(54) GAME SYSTEM

(71) Applicant: TOYOTA JIDOSHA KABUSHIKI KAISHA, Toyota-shi (JP)

(72) Inventors: Motohiro KOJIMA, Okazaki-shi (JP); Koji Aikawa, Nagoya-shi (JP); Morihiko Yoshida, Toyota-shi (JP); Tadahiro Nishikawa, Nisshin-shi (JP); Yasuhiro Miura, Owariasahi-shi (JP); Kuka Ishiyama, Tokyo (JP); Hideki Kobayashi, Miyoshi-shi (JP); Yuji Ota, Kariya-shi (JP); Yasuhiro Ishiguro, Nisshin-shi (JP); Motoki Maekawa, Nagakute-shi (JP); Hiroshi Mizobata, Seto-shi (JP); Takashi Nonogawa, Kasugai-shi (JP)

(73) Assignee: TOYOTA JIDOSHA KABUSHIKI KAISHA, Toyota-shi (JP)

(21) Appl. No.: 18/400,088

(22) Filed: Dec. 29, 2023

(30) Foreign Application Priority Data
Mar. 3, 2023 (JP) 2023-033198

(51) Int. Cl. A63F 13/45; A63F 13/65; A63F 13/67; A63F 13/803; A63F 13/92

(52) U.S. Cl. CPC A63F 13/45; A63F 13/65; A63F 13/67; A63F 13/803; A63F 13/92

(57) ABSTRACT

The game system includes a first acquisition unit that acquires vehicle information about a vehicle, and a first transmission unit that transmits the vehicle information acquired by the first acquisition unit to a personal terminal brought into the vehicle. A vehicle-mounted device mounted on the vehicle; a second acquisition unit that acquires the vehicle information transmitted from the first transmission unit; and the vehicle information acquired by the second acquisition unit, on the personal terminal and the personal terminal including a control unit that controls the progress of the game by using it as a parameter of the game that is being executed.

### CROSS-REFERENCE TO RELATED APPLICATION

This application claims priority to Japanese Patent Application No. 2023-033198 filed on Mar. 3, 2023 incorporated herein by reference in its entirety.

### BACKGROUND

### 1. Technical Field

The present disclosure relates to game systems.

### 2. Description of Related Art

Japanese Unexamined Patent Application Publication No. 2014-188010 (JP 2014-188010 A) discloses a technique that enables the progress of a game by using real-world driving of a vehicle such as an automobile and without wasting the driving of the vehicle at all.

### SUMMARY

The technique described in JP 2014-188010 A includes a probe device that transmits collected travel data of the vehicle to a game device. The probe device is a mobile terminal (such as a smart phone) in which an application for car navigation is installed. The game device executes a game in which the vehicle moves (travels) in virtual space in accordance with the traveling distance of the vehicle indicated by the travel data. As described above, the technique requires another device for controlling the progress of the game being executed by the game device, and has a complicated configuration.

Therefore, an object of the present disclosure is to provide a game system that can control the progress of a game being executed on a terminal by using vehicle information transmitted from a configuration mounted on a vehicle to the terminal brought into the vehicle.

A game system according to claim 1 includes an on-board device mounted on a vehicle; and a personal terminal. The on-board device includes a first acquisition unit that acquires vehicle information about a vehicle, and a first transmission unit that transmits the vehicle information acquired by the first acquisition unit to the personal terminal brought into the vehicle.

The personal terminal includes a second acquisition unit that acquires the vehicle information transmitted from the first transmission unit, and a control unit that controls progress of a game by using the vehicle information acquired by the second acquisition unit as a parameter of the game being executed on the personal terminal.

In the game system according to claim 1, the first acquisition unit of the on-board device acquires vehicle information. The first transmission unit of the on-board device transmits the vehicle information acquired by the first acquisition unit to the personal terminal. The second acquisition unit of the personal terminal acquires the vehicle information transmitted from the first transmission unit. The control unit of the personal terminal controls the progress of the game by using the vehicle information acquired by the second acquisition unit as the parameter of the game. Accordingly, with the game system, it is possible to control the progress of a game being executed on a personal terminal by using vehicle information transmitted from an on-board device to the personal terminal.

In the game system according to claim 2, in claim 1, the on-board device includes a generation unit that processes the vehicle information acquired by the first acquisition unit to generate processed information, the first transmission unit transmits the processed information generated by the generation unit to the personal terminal, the second acquisition unit acquires the processed information transmitted from the first transmission unit, and the control unit controls the progress of the game by using the processed information acquired by the second acquisition unit as the parameter of the game.

In the game system according to claim 2, the generation unit of the on-board device processes the vehicle information acquired by the first acquisition unit to generate the processed information. The first transmission unit of the on-board device transmits the processed information generated by the generation unit to the personal terminal. The second acquisition unit of the personal terminal acquires the processed information transmitted from the first transmission unit. The control unit of the personal terminal controls the progress of the game by using the processed information acquired by the second acquisition unit as the parameter of the game. Accordingly, with the game system, by not transmitting vehicle information as it is to a personal terminal, it is possible to increase the security of the vehicle information while reducing the amount of communication.

In the game system according to claim 3, in claim 2, the generation unit generates, as the processed information, evaluation information indicating an evaluation of driving of a driver of the vehicle based on the vehicle information acquired by the first acquisition unit, the first transmission unit transmits the evaluation information generated by the generation unit to the personal terminal, the second acquisition unit acquires the evaluation information transmitted from the first transmission unit, and the control unit advances the game in an advantageous or disadvantageous manner based on the evaluation indicated by the evaluation information acquired by the second acquisition unit.

In the game system according to claim 3, the generation unit of the on-board device generates the evaluation information as the processed information. The first transmission unit of on-board device transmits the evaluation information generated by the generation unit to the personal terminal. The second acquisition unit of the personal terminal acquires the evaluation information transmitted from the first transmission unit. The control unit of the personal terminal advances the game in an advantageous or disadvantageous manner based on the evaluation indicated by the evaluation information acquired by the second acquisition unit. Accordingly, with this game system, since the details of driving performed by a driver are related to the progress of a game, activation of communication between a player of the game and the driver can be expected in order to advance the game in an advantageous manner.

The game system according to claim 4, in claim 2, further includes a server. The on-board device includes a second transmission unit that transmits the vehicle information acquired by the first acquisition unit or the processed information generated by the generation unit to the server, and the server includes a third acquisition unit that acquires the vehicle information or the processed information transmitted from the second transmission unit included in the on-board device mounted in each of a plurality of the vehicles, and a third transmission unit that transmits a content of the game determined based on the vehicle information or the processed information acquired by the third acquisition unit to the personal terminal.

In the game system according to claim 4, the second transmission unit of the on-board device transmits the vehicle information acquired by the first acquisition unit or the processed information generated by the generation unit to the server. The third acquisition unit of the server acquires the vehicle information or the processed information transmitted from the second transmission unit included in the on-board device mounted in each of the vehicles. The third transmission unit of the server transmits the content of the game determined based on the vehicle information or the processed information acquired by the third acquisition unit to the personal terminal. Accordingly, with the game system, it is possible to execute a game that reflects an external environment based on information transmitted from a plurality of vehicles.

In the game system according to claim 5, in claim 4, the second acquisition unit acquires the content transmitted from the third transmission unit, and the control unit uses the content acquired by the second acquisition unit as a parameter constituting a stage of the game, and presents a situation of the stage to a player of the game.

In the game system according to claim 5, the second acquisition unit of the personal terminal acquires the content transmitted from the third transmission unit. The control unit of the personal terminal uses the content acquired by the second acquisition unit as the parameter constituting the stage of the game, and presents the situation of the stage to the player of the game. Accordingly, with the game system, since an external environment based on information transmitted from a plurality of vehicles is reflected in the stage of a game, it is possible to provide a game experience in which the real space is linked to the game space.

As described above, with the game system according to the present disclosure, it is possible to control the progress of a game being executed on a terminal by using vehicle information transmitted from a configuration mounted on a vehicle to the terminal brought into the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a game system;

FIG. 2 is a block diagram showing the hardware configuration of the vehicle;

FIG. 3 is a block diagram showing the hardware configuration of a personal terminal;

FIG. 4 is a block diagram showing the hardware configuration of the server;

FIG. 5 is a first sequence diagram showing an example of the flow of the game system; and

FIG. 6 is a second sequence diagram showing an example of the flow of the game system.

### DETAILED DESCRIPTION OF EMBODIMENTS

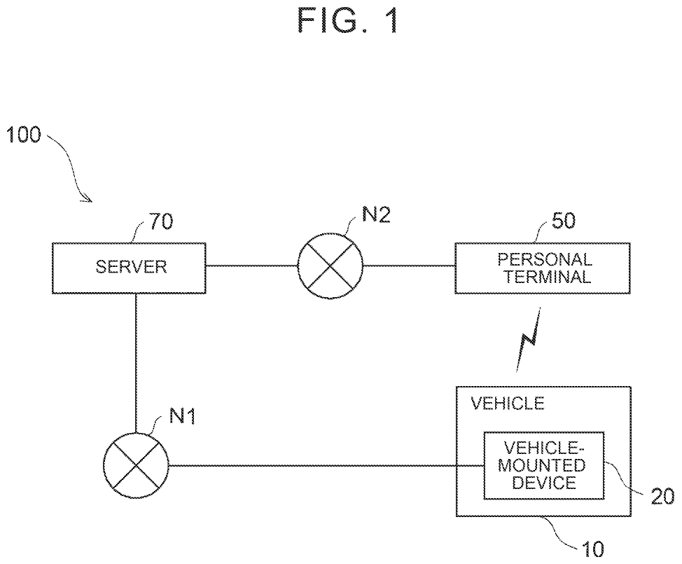

The game system 100 according to this embodiment will be described below. FIG. 1 is a diagram showing a schematic configuration of a game system 100.

As shown in FIG. 1, the game system 100 includes a vehicle 10, a personal terminal 50, and a server 70. The vehicle-mounted device 20 and the personal terminal 50 mounted on the vehicle 10 are connected via wireless communication. The vehicle-mounted device 20 and the server 70 are connected via a network N1. The personal terminal 50 and the server 70 are connected via the network N2.

The vehicle 10 is a so-called connected car capable of transmitting information such as the state of the vehicle and surrounding conditions to the personal terminal 50 and the server 70. Although one vehicle 10 is shown in FIG. 1, the number of connected cars present in the game system 100 is not limited to one, and may be multiple.

The personal terminal 50 is a mobile terminal owned by a passenger of the vehicle 10, specifically, a passenger other than the driver. In this embodiment, as an example, the personal terminal 50 is a smart phone.

The server 70 is a server computer owned by a predetermined business operator.

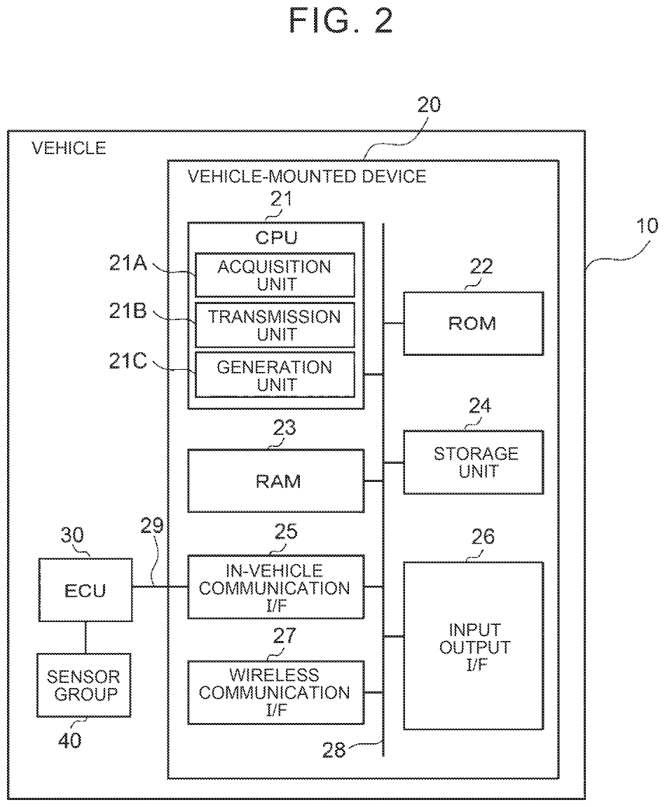

FIG. 2 is a block diagram showing the hardware configuration of the vehicle 10. As shown in FIG. 2, the vehicle 10 includes a vehicle-mounted device 20, an Electronic Control Unit (ECU) 30 and a sensor group 40.

The vehicle-mounted device 20 includes a Central Processing Unit (CPU) 21, a Read Only Memory (ROM) 22, a Random Access Memory (RAM) 23, a storage unit 24, an in-vehicle communication interface (I/F) 25, an input output I/F 26 and wireless communication I/F 27. The CPU 21, ROM 22, RAM 23, storage unit 24, in-vehicle communication I/F 25, input output I/F 26, and wireless communication I/F 27 are connected via an internal bus 28 so as to be able to communicate with each other.

The CPU 21 is a central processing unit that executes various programs and controls each section. That is, the CPU 21 reads a program from the ROM 22 or the storage unit 24 and executes the program using the RAM 23 as a work area. The CPU 21 performs control of the above components and various arithmetic processing according to programs recorded in the ROM 22 or the storage unit 24.

The ROM 22 stores various programs and various data. The RAM 23 temporarily stores programs or data as a work area.

The storage unit 24 is configured by a storage device such as an embedded Multi Media Card (eMMC) or Universal Flash Storage (UFS), and stores various programs and various data.

The in-vehicle communication I/F 25 is an interface for connecting with the ECU 30. The interface uses a communication standard based on the CAN protocol. In-vehicle communication I/F 25 is connected to external bus 29. In addition to the ECU 30, a plurality of ECUs are provided for each function of the vehicle 10, although illustration is omitted.

Here, a sensor group 40 is connected to the ECU 30. For example, the sensor group 40 includes a 3D-LiDAR, a millimeter wave sensor, an infrared sensor, a turn signal sensor, a vehicle speed sensor, a steering angle sensor, an angular velocity sensor, a Global Positioning System (GPS) sensor, a gyro sensor, and an acceleration sensor of the vehicle 10. It has sensors for detecting state and surroundings. The sensor group 40 outputs the detection result of each sensor to the ECU 30.

The input output I/F 26 is an interface for communicating with in-vehicle equipment (not shown) mounted on the vehicle 10.

A wireless communication I/F 27 is a wireless communication module for communicating with the personal terminal 50 and the server 70. The wireless communication module uses communication standards such as 5G, LTE, Wi-Fi (registered trademark), and Bluetooth (registered trademark).

In addition, the CPU 21 of the vehicle-mounted device 20 has an acquisition unit 21A, a transmission unit 21B, and a generation unit 21C as functional configurations. Each functional configuration is realized by the CPU 21 reading and executing a program stored in the ROM 22 or the storage unit 24.

The acquisition unit 21A acquires vehicle information about the vehicle 10. For example, the acquisition unit 21A acquires CAN data of the vehicle 10 input from the ECU 30 via the in-vehicle communication I/F 25 as vehicle information. The acquisition unit 21A is an example of a “first acquisition unit”.

The transmission unit 21B transmits the CAN data acquired by the acquisition unit 21A to the personal terminal 50 brought into the vehicle 10. As an example, the transmission unit 21B transmits the acquired CAN data to the personal terminal 50 whenever the acquisition unit 21A acquires CAN data.

The generation unit 21C processes the CAN data acquired by the acquisition unit 21A to generate processed information. The processed information is information in which the CAN data is processed so that the CAN data itself cannot be identified. Also, the data amount of the processing information is smaller than the data amount of the CAN data per unit time. As an example, the generation unit 21C generates, as the processed information, evaluation information that evaluates the driving of the driver of the vehicle 10 based on the CAN data acquired by the acquisition unit 21A. At this time, the generation unit 21C generates evaluation information within the sampling period each time the number of CAN data acquired by the acquisition unit 21A reaches a predetermined sampling number. Also, the type and number of CAN data used to generate the evaluation information are not particularly limited.

For example, the generation unit 21C evaluates the driver's driving based on the evaluation items of accelerator, steering, brake, and eco. The generation unit 21C calculates the evaluation value of each evaluation item based on the CAN data, and totals the calculated evaluation values to calculate the total evaluation value. Then, the generation unit 21C generates evaluation information indicating “good” when the total evaluation value is equal to or higher than the first criterion, and evaluation information indicating “bad” when the total evaluation value is equal to or lower than the second criterion, which is lower than the first criterion.

As described above, when the generation unit 21C generates the processed information, the transmission unit 21B transmits the processed information (“evaluation information” in the above example) to the personal terminal 50 based on the generation of the processed information. Send to Whether or not the generation unit 21C generates the processed information may be determined by an input operation on the vehicle 10 or the personal terminal 50.

Here, the transmission unit 21B transmits to the server 70 the CAN data acquired by the acquisition unit 21A or the processed information generated by the generation unit 21C. The timing of transmitting the CAN data or processed information to the server 70 is the same as the timing of transmitting the CAN data or processed information to the personal terminal 50 described above. The transmission unit 21B is an example of the “first transmission unit” and the “second transmission unit”.

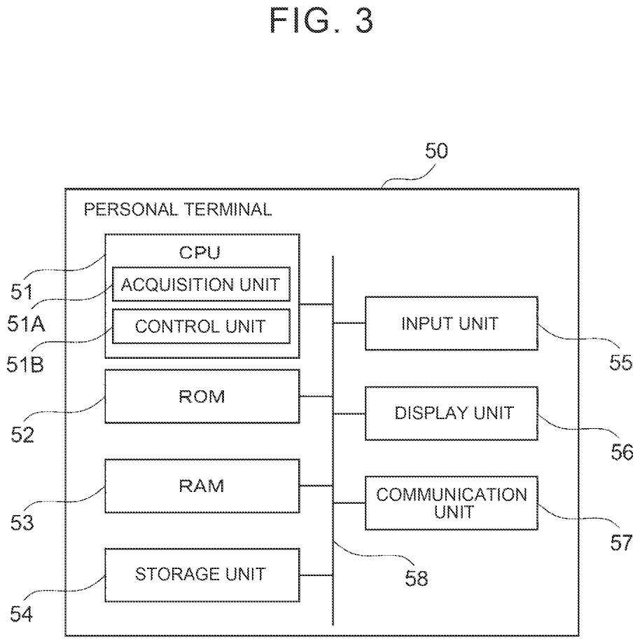

Next, the hardware configuration of the personal terminal 50 will be explained. FIG. 3 is a block diagram showing the hardware configuration of the personal terminal 50.

As shown in FIG. 3, the personal terminal 50 includes a CPU 51, ROM 52, RAM 53, storage section 54, input section 55, display section 56 and communication section 57. Each component is communicatively connected to each other via a bus 58. Note that the hardware configuration of the personal terminal 50 is the same as that of a general smart phone, so details thereof will be omitted.

The CPU 51 of the personal terminal 50 has an acquisition unit 51A and a control unit 51B as functional configurations. Each functional configuration is realized by the CPU 51 reading and executing a program stored in the ROM 52 or the storage unit 54.

51 A of acquisition parts acquire at least one of the CAN data and process information which were transmitted from the transmission unit 21B of the vehicle-mounted device 20. Acquisition unit 51A is an example of a “second acquisition unit”.

The control unit 51B uses at least one of the CAN data and the processed information acquired by the acquisition unit 51A as parameters of the game being executed on the personal terminal 50 to control the progress of the game. The game is a computer game whose progress can be controlled based on information from the vehicle-mounted device 20.

A specific example of the content of control by the control unit 51B will be described later, but for example, the control unit 51B advances the game in an advantageous or disadvantageous manner based on the evaluation indicated by the evaluation information acquired as the processed information by the acquisition unit 51A.

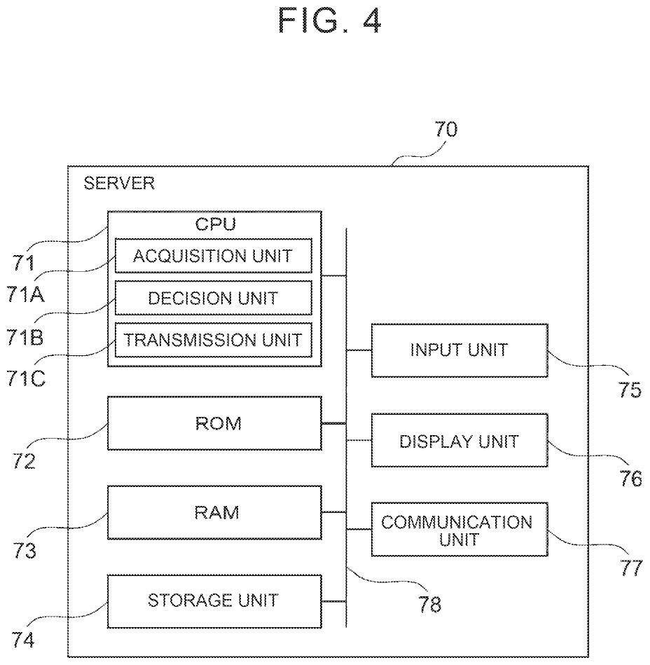

Next, the hardware configuration of the server 70 will be explained. FIG. 4 is a block diagram showing the hardware configuration of the server 70.

As shown in FIG. 4, the server 70 includes a CPU 71, ROM 72, RAM 73, storage section 74, input section 75, display section 76 and communication section 77. Each component is communicatively connected to each other via a bus 78. Note that the hardware configuration of the server 70 is the same as that of a general server computer, so details thereof will be omitted.

The CPU 71 of the server 70 has an acquisition unit 71A, a determination unit 71B, and a transmission unit 71C as functional configurations. Each functional configuration is realized by the CPU 71 reading and executing a program stored in the ROM 72 or the storage unit 74.

The acquisition unit 71A acquires CAN data or processed information transmitted from the transmission unit 21B included in the vehicle-mounted device 20 mounted on each of the plurality of vehicles 10. The CAN data or the processed information acquired by the acquisition unit 71A is stored in the storage unit 74. The acquisition unit 71A is an example of a “third acquisition unit”.

The determination unit 71B determines game content based on the CAN data or the processed information acquired by the acquisition unit 71A. Here, game content is stored in the storage unit 74. Then, the determination unit 71B determines content corresponding to the acquired CAN data or processed information from the storage unit 74. For example, the determination unit 71B determines content corresponding to the outside temperature of the vehicle 10 estimated from the acquired CAN data and content corresponding to the traffic volume around the vehicle 10 estimated from the CAN data. Further, the determination unit 71B determines the content corresponding to the evaluation indicated by the acquired processing information, specifically, the evaluation information.

The transmission unit 71C transmits the content to the personal terminal 50 based on the content determined by the determination unit 71B. The transmission unit 71C is an example of a “third transmission unit”.

Here, the acquisition unit 51A of the personal terminal 50 acquires the content transmitted from the transmission unit 71C. Then, the control unit 51B of the personal terminal 50 uses the content acquired by the acquisition unit 51A as parameters constituting the stage of the game, and presents the situation of the stage to the player of the game.

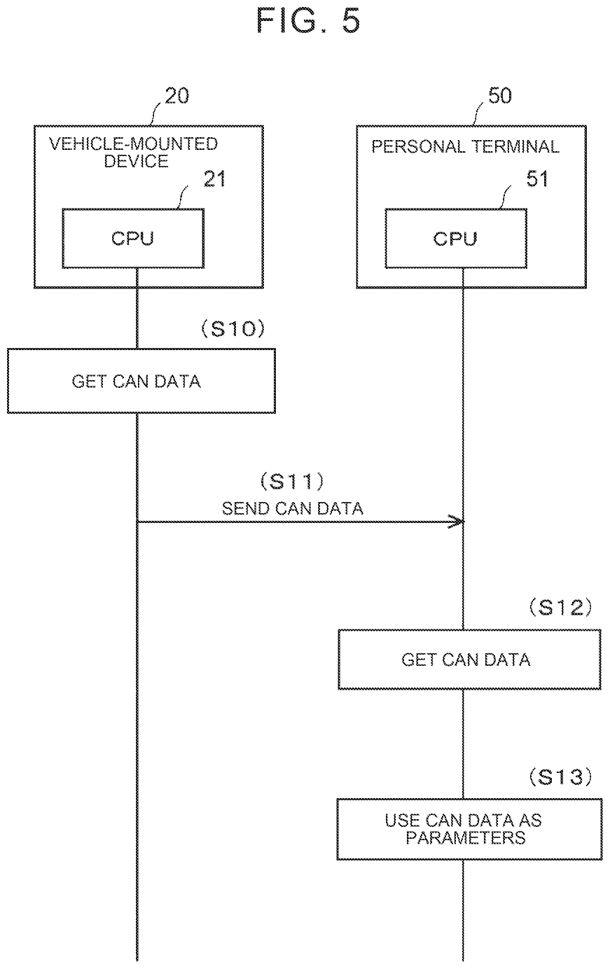

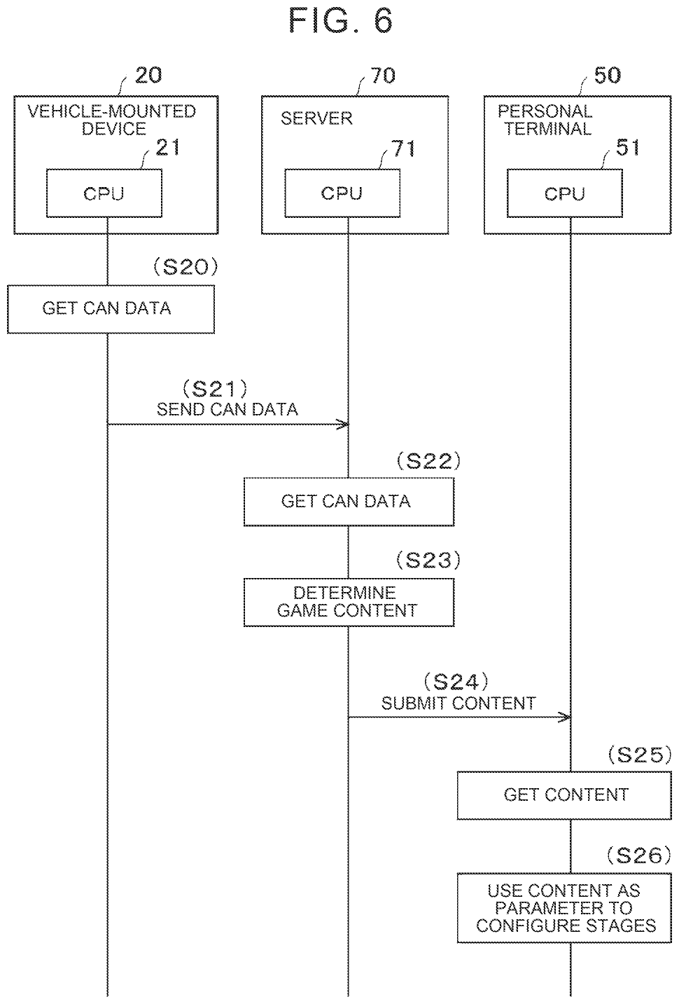

Next, an example of the flow of the game system 100 will be described with reference to the sequence diagrams of FIGS. 5 and 6. FIG. 5 is a first sequence diagram showing an example of the flow of the game system 100. The sequence diagram shows an example of the flow of the game system 100 between the vehicle-mounted device 20 and the personal terminal 50.

In S10 of FIG. 5, the CPU 21 of the vehicle-mounted device 20 acquires CAN data of the vehicle 10 as vehicle information. At S11, the CPU 21 transmits the CAN data acquired at S10 to the personal terminal 50.

At S12, the CPU 51 of the personal terminal 50 acquires the CAN data transmitted from the vehicle-mounted device 20 at S11. In S13, the CPU 51 uses the CAN data acquired in S12 as game parameters to control the progress of the game. An example of using CAN data as a parameter is as follows.

### (1) When a Game is Running to Predict which Turn Signal will be Used Next

In the case of (1), the CPU 51 identifies the blinker used from the blinker signal included in the CAN data. Then, the CPU 51 uses the CAN data as a parameter for judging whether the player is right or wrong, and expresses on the game that if the used blinker matches the player's expectation, the player has guessed correctly. On the other hand, the CPU 51 expresses on the game that if the blinker used does not match the player's expectation, the answer is incorrect.

### (2) When a Game is Being Executed to Predict the Distance Traveled by the Vehicle 10 within a Predetermined Time

In the case of (2), the CPU 51 specifies the distance traveled by the vehicle 10 within a predetermined time from the CAN data. Then, the CPU 51 uses the CAN data as a parameter for judging whether the game is correct or not, and if the difference between the actual distance traveled and the player's prediction is within a predetermined value, the CPU 51 expresses that the game is correct. On the other hand, the CPU 51 expresses on the game that the answer is incorrect if the error between the actual distance traveled and the player's prediction is not within a predetermined value.

### (3) When Embodying the Movement of the Vehicle 10 on the Game

In the case of (3), the CPU 51 uses the steering angle signal and vehicle speed signal included in the CAN data as parameters related to the movement of the moving object in the game (e.g., parameters such as movement direction, movement amount, and movement speed). Based on the CAN data, the CPU 51 implements the movement of the vehicle 10 on the game using the mobile object.

In addition, since most of the flow when the vehicle-mounted device 20 transmits the processing information overlaps with the above contents, the difference will be mainly described.

The CPU 21 of the vehicle-mounted device 20 processes the acquired CAN data, generates evaluation information as processed information, and transmits the evaluation information to the personal terminal 50. The CPU 51 of the personal terminal 50 uses the evaluation information transmitted from the vehicle-mounted device 20 as game parameters to control the progress of the game. For example, when the obtained evaluation information is “good”, the CPU 51 advances the game advantageously by improving the ability of the character or lowering the difficulty of missions that affect the progress of the game. On the other hand, when the obtained evaluation information is “bad”, the CPU 51 lowers the character's ability or increases the difficulty of the mission to advance the game disadvantageously.

FIG. 6 is a second sequence diagram showing an example of the flow of the game system 100. The sequence diagram shows an example of the flow of the game system 100 among the vehicle-mounted device 20, the server 70 and the personal terminal 50. 6, the flow of the game system 100 between the vehicle-mounted device 20 and the personal terminal 50 similar to the sequence diagram shown in FIG. 5 is omitted. Also, the description of the same parts as those in the sequence diagram shown in FIG. 5 will be omitted below.

In S20 of FIG. 6, the CPU 21 of the vehicle-mounted device 20 acquires CAN data of the vehicle 10 as vehicle information. At S21, the CPU 21 transmits the CAN data acquired at S20 to the server 70.

At S22, the CPU 71 of the server 70 acquires the CAN data transmitted from the vehicle-mounted device 20 at S21. Specifically, the CPU 71 acquires CAN data transmitted from the vehicle-mounted device 20 mounted on each of the plurality of vehicles 10.

At S23, the CPU 71 of the server 70 determines game content based on the CAN data acquired at S22. For example, it is assumed that the CPU 71 has determined, as content corresponding to the outside air temperature of the vehicle 10 estimated from CAN data, content indicating cold regions such as snowy mountains or ice caves. At S24, the CPU 71 transmits the content determined at S23 to the personal terminal 50.

At S25, the CPU 51 of the personal terminal 50 acquires the content transmitted from the server 70 at S24. At S26, the CPU 51 presents the status of the stage to the player of the game, using the content obtained at S25 as the parameters constituting the stage. For example, the CPU 51 causes a cold zone stage indicated by the acquired content to newly appear in the game, or changes the stage of the game being executed to a cold zone indicated by the acquired content.

In addition, since most of the flow when the vehicle-mounted device 20 transmits the processing information overlaps with the above contents, the difference will be mainly described.

The CPU 21 of the vehicle-mounted device 20 processes the acquired CAN data, generates evaluation information, for example, as processed information, and transmits the evaluation information to the server 70. The CPU 71 of the server 70 determines game content based on the evaluation information transmitted from the vehicle-mounted device 20 mounted on each of the plurality of vehicles 10. For example, the CPU 71 determines, as content to be transmitted to the personal terminal 50, content indicating items placed on the stage corresponding to each location according to the evaluation information at each location traveled by the plurality of vehicles 10. As an example, an item is a tool for advancing a game advantageously. The CPU 71 then transmits the determined content to the personal terminal 50. The CPU 51 of the personal terminal 50 uses the contents transmitted from the server 70 as parameters for configuring the stages of the game, and presents the status of the stages to the player of the game. For example, the CPU 51 arranges items indicated by the acquired content in each stage of the game being executed so that the player can recognize them.

As described above, in the game system 100, the CPU 21 of the vehicle-mounted device 20 acquires the CAN data of the vehicle 10 and transmits the acquired CAN data to the personal terminal 50. In addition, the CPU 51 of the personal terminal 50 acquires the CAN data transmitted from the vehicle-mounted device 20, uses the acquired CAN data as game parameters, and controls the progress of the game. Thus, in the game system 100, the CAN data transmitted from the vehicle-mounted device 20 to the personal terminal 50 can be used to control the progress of the game being executed on the personal terminal 50.

In the game system 100, the CPU 21 of the vehicle-mounted device 20 processes the acquired CAN data to generate processed information, and transmits the generated processed information to the personal terminal 50. In addition, the CPU 51 of the personal terminal 50 acquires the processing information transmitted from the vehicle-mounted device 20, uses the acquired processing information as game parameters, and controls the progress of the game. As a result, in the game system 100, the CAN data is not transmitted to the personal terminal 50 as it is, thereby reducing the amount of communication and increasing the security of the CAN data.

In the game system 100, the CPU 21 of the vehicle-mounted device 20 generates evaluation information as processed information and transmits the generated evaluation information to the personal terminal 50. Also, the CPU 51 of the personal terminal 50 acquires the evaluation information transmitted from the vehicle-mounted device 20, and advances the game in an advantageous or disadvantageous manner based on the evaluation indicated by the acquired evaluation information. As a result, in the game system 100, the details of driving by the driver are related to the progress of the game, so it can be expected that communication between the game player and the driver will be activated in order to advance the game advantageously.

Also, in the game system 100, the CPU 21 of the vehicle-mounted device 20 transmits CAN data or processing information to the server 70. The CPU 71 of the server 70 also acquires CAN data or processing information transmitted from the plurality of vehicle-mounted devices 20 and transmits game content determined based on the acquired CAN data or processing information to the personal terminal 50. As a result, in the game system 100, it is possible to execute a game that reflects the external environment based on the information transmitted from the plurality of vehicles 10.

Also, in the game system 100, the CPU 51 of the personal terminal 50 acquires the content transmitted from the server 70, uses the acquired content as parameters configuring the stage, and presents the state of the stage to the player. Thus, in the game system 100, the external environment based on the information transmitted from the plurality of vehicles 10 is reflected in the game stage, so that a game experience in which the real space and the game space are linked can be provided.

### Others

In the above embodiment, the vehicle-mounted device 20 transmits either CAN data or processed information to the personal terminal 50 and the server 70. However, not limited to this, the vehicle-mounted device 20 may transmit both the CAN data and the processed information to the personal terminal 50 and the server 70.

In the above embodiment, the vehicle-mounted device 20 transmits acquired CAN data to the personal terminal 50 or the server 70 as needed. However, not limited to this, the vehicle-mounted device 20 may transmit arbitrary data in the acquired CAN data to the personal terminal 50 or the server 70 at arbitrary timing.

In the above embodiment, a form is explained in which the program for each of the vehicle-mounted device 20, the personal terminal 50, and the server 70 to execute the process of the sequence diagram shown in FIG. 5 or 6 is pre-stored (installed) in the ROM 22 or the storage unit 24, the ROM 52 or the storage unit 54, and the ROM 72 or the storage unit 74, but the present disclosure is not limited to this. Each program may be provided in a form of being stored in a recording medium such as Compact Disk Read Only Memory (CD-ROM), Digital Versatile Disk Read Only Memory (DVD-ROM), and Universal Serial Bus (USB) memory. Also, each program may be downloaded from an external device via a network.

What is claimed is:

1. A game system comprising: an on-board device mounted on a vehicle; and a personal terminal, wherein:
the on-board device includes
a first acquisition unit that acquires vehicle information about a vehicle, and
a first transmission unit that transmits the vehicle information acquired by the first acquisition unit to the personal terminal brought into the vehicle; and
the personal terminal includes
a second acquisition unit that acquires the vehicle information transmitted from the first transmission unit, and
a control unit that controls progress of a game by using the vehicle information acquired by the second acquisition unit as a parameter of the game being executed on the personal terminal.

2. The game system according to claim 1, wherein:
the on-board device includes a generation unit that processes the vehicle information acquired by the first acquisition unit to generate processed information;
the first transmission unit transmits the processed information generated by the generation unit to the personal terminal;
the second acquisition unit acquires the processed information transmitted from the first transmission unit; and
the control unit controls the progress of the game by using the processed information acquired by the second acquisition unit as a parameter of the game.

3. The game system according to claim 2, wherein:
the generation unit generates, as the processed information, evaluation information indicating an evaluation of driving of a driver of the vehicle based on the vehicle information acquired by the first acquisition unit;
the first transmission unit transmits the evaluation information generated by the generation unit to the personal terminal;
the second acquisition unit acquires the evaluation information transmitted from the first transmission unit; and
the control unit advances the game in an advantageous or disadvantageous manner based on the evaluation indicated by the evaluation information acquired by the second acquisition unit.

4. The game system according to claim 2, further comprising a server, wherein:
the on-board device includes a second transmission unit that transmits the vehicle information acquired by the first acquisition unit or the processed information generated by the generation unit to the server; and
the server includes
a third acquisition unit that acquires the vehicle information or the processed information transmitted from the second transmission unit included in the on-board device mounted in each of a plurality of the vehicles, and
a third transmission unit that transmits a content of the game determined based on the vehicle information or the processed information acquired by the third acquisition unit to the personal terminal.

5. The game system according to claim 4, wherein:
the second acquisition unit acquires the content transmitted from the third transmission unit; and
the control unit uses the content acquired by the second acquisition unit as a parameter constituting a stage of the game, and presents a situation of the stage to a player of the game.
